(19) United States
(12) Patent Application Publication
(10) Pub. No.: US 2023/0333218 A1
(43) Pub. Date: Oct. 19, 2023

(54) RANGE IMAGING APPARATUS AND RANGE IMAGING METHOD

(71) Applicant: TOPPAN Inc., Tokyo (JP)

(72) Inventors: Kunihiro HATAKEYAMA, Taito-ku (JP); Tomohiro NAKAGOME, Taito-ku (JP)

(73) Assignee: TOPPAN Inc., Tokyo (JP)

(21) Appl. No.: 18/340,932

(22) Filed: Jun. 26, 2023

Related U.S. Application Data
(63) Continuation of application No. PCT/JP2021/047901, filed on Dec. 23, 2021.

(30) Foreign Application Priority Data
Dec. 24, 2020 (JP) 2020-215032

(51) Int. Cl. G01S 7/4863; G01S 17/89

(52) U.S. Cl. CPC G01S 7/4863; G01S 17/89

(57) ABSTRACT

A range imaging apparatus includes a light source unit that emits light pulse to a measurement space, a light receiver including pixels and a pixel driver circuit, and a range image processor that determines a measurement distance to a subject placed in the space. Each pixel includes a photoelectric conversion device that generates electric charge corresponding to incident light and charge accumulators that store the electric charge, the circuit distributes and stores the charge to each accumulator at a predetermined point in time synchronized with emission of the pulse, the processor acquires waveform information indicating degree of distortion of waveform of rectangular signal having distorted waveform, corrects, based on the information, charge amounts each indicating an amount of the electric charge stored when the waveform has no distortion, and determines the distance using the charge amounts, and the signal is used in signal processing performed until the distance is determined.

### CROSS-REFERENCE TO RELATED APPLICATIONS

The present application is a continuation of and claims the benefit of priority to International Application No. PCT/JP2021/047901, filed Dec. 23, 2021, which is based upon and claims the benefit of priority to Japanese Application No. 2020-215032, filed Dec. 24, 2020. The entire contents of these applications are incorporated herein by reference.

### BACKGROUND OF THE INVENTION

### Field of the Invention

The present invention relates to a range imaging apparatus and a range imaging method.

### Description of Background Art

For example, JP 4235729 B describes a technique in which each pixel includes three charge accumulators and that calculates the distance by distributing the electric charge in order. The entire contents of this publication are incorporated herein by reference.

### SUMMARY OF THE INVENTION

According to one aspect of the present invention, a range imaging apparatus includes a light source unit that emits a light pulse to a measurement space, a light receiver including pixels and a pixel driver circuit, and a range image processor that determines a measurement distance to a subject placed in the measurement space. Each of the pixels in the light receiver includes a photoelectric conversion device that generates an electric charge corresponding to incident light and charge accumulators that store the electric charge, the pixel driver circuit in the light receiver distributes and stores the electric charge to each of the charge accumulators of each of the pixels at a predetermined point in time synchronized with emission of the light pulse, the range image processor acquires waveform information indicating a degree of distortion of a waveform of a rectangular signal having a distorted waveform, corrects, based on the waveform information, charge amounts each indicating an amount of the electric charge that is stored when the waveform of the rectangular signal has no distortion, and determines the measurement distance to the subject using the charge amounts, and the rectangular signal is used in signal processing performed until the measurement distance is determined.

According to another aspect of the present invention, a range imaging method includes providing a range imaging apparatus including a light source unit that emits a light pulse to a measurement space, a light receiver including pixels and a pixel driver circuit, and a range image processor that determines a measurement distance to a subject in the measurement space, causing a range image processor to acquire waveform information indicating a degree of distortion of a waveform of a rectangular signal having a distorted waveform, correct, based on the waveform information, charge amounts each indicating an amount of an electric charge that is stored when the waveform of the rectangular signal has no distortion, and determine the measurement distance to the subject using the charge amounts. Each of the pixels in the light receiver includes a photoelectric conversion device that generates the electric charge corresponding to incident light and charge accumulators that store the electric charge, the pixel driver circuit in the light receiver distributes and stores the electric charge to each of the charge accumulators of each of the pixels at a predetermined point in time synchronized with emission of the light pulse, the range image processor acquires the waveform information, corrects the charge amounts based on the waveform information, and determines the measurement distance to the subject, and the rectangular signal is used in signal processing performed until the measurement distance is determined.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram illustrating a schematic configuration of a range imaging apparatus according to an embodiment of the present invention;

FIG. 2 is a block diagram illustrating a schematic configuration of a range image sensor according to an embodiment of the present invention;

FIG. 3 is a circuit diagram illustrating an exemplary configuration of a pixel according to an embodiment of the present invention;

FIG. 4 is a timing diagram illustrating an example of points in time at which each pixel according to an embodiment of the present invention is driven;

FIG. 5 is a graph illustrating waveform distortion according to an embodiment of the present invention;

FIG. 6 is a graph illustrating waveform distortion according to an embodiment of the present invention;

FIG. 7 is a graph illustrating waveform distortion according to an embodiment of the present invention;

FIG. 8 is a table illustrating an exemplary configuration of waveform information according to an embodiment of the present invention;

FIG. 9 is a diagram illustrating a process of correcting charge amounts performed by a range image processor according to an embodiment of the present invention;

FIG. 10 is a flowchart illustrating a process flow performed by a range image processor according to t an embodiment of the present invention;

FIG. 11 is a timing diagram illustrating an example of points in time at which each pixel according to a modification of an embodiment of the present invention is driven;

FIG. 12 is a diagram illustrating a process of correcting a charge amount performed by a range image processor according to a modification of an embodiment of the present invention;

FIG. 13 is a graph illustrating an advantageous effect according to an embodiment of the present invention; and

FIG. 14 is a graph illustrating two time windows according to a modification of an embodiment of the present invention.

### DETAILED DESCRIPTION OF THE EMBODIMENTS

Embodiments will now be described with reference to the accompanying drawings, wherein like reference numerals designate corresponding or identical elements throughout the various drawings. A range imaging apparatus according to an embodiment will be described below with reference to the drawings.

### Embodiment

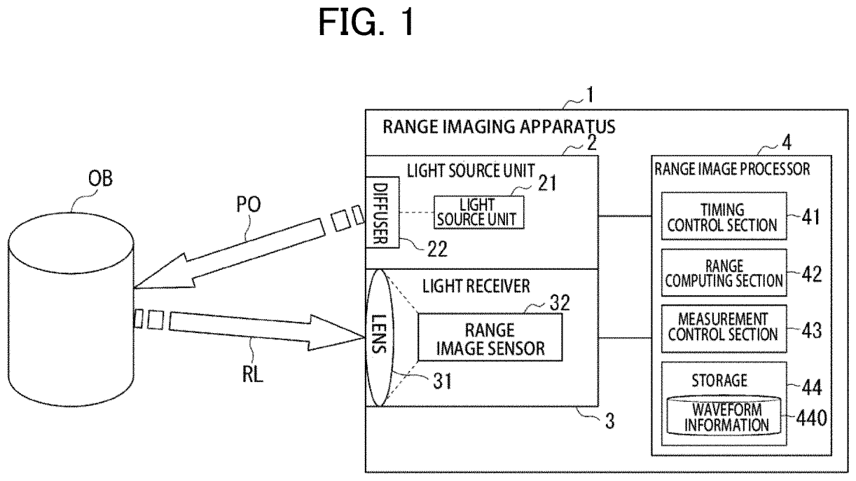

An embodiment will now be described. FIG. 1 is a block diagram illustrating a schematic configuration of a range imaging apparatus according to a first embodiment of the present invention. A range imaging apparatus 1 configured as illustrated in FIG. 1 includes a light source unit 2, a light receiver 3, and a range image processor 4. FIG. 1 also illustrates a subject OB the distance to which will be measured by the range imaging apparatus 1.

In response to a control procedure performed by the range image processor 4, the light source unit 2 emits a light pulse PO into a space of which an image will be taken and in which the subject OB exists. The range imaging apparatus 1 measures the distance to the subject OB. The light source unit 2 may be, for example, a surface emitting semiconductor laser module such as a vertical cavity surface emitting laser (VCSEL). The light source unit 2 includes a light source device 21 and a diffuser 22.

The light source device 21 is a light source that emits a laser beam in a near-infrared wavelength band (for example, a wavelength band in which the wavelength is 850 nm to 940 nm), which serves as the light pulse PO projected to the subject OB. The light source device 21 may be, for example, a semiconductor laser light emitting device. The light source device 21 emits a pulsed laser beam in response to the control procedure performed by a timing control section 41.

The diffuser 22 is an optical component that diffuses the laser beam in a near-infrared wavelength band emitted from the light source device 21 over an area in which the subject OB is irradiated with the diffused laser beam. The pulsed laser beam diffused by the diffuser 22 is output as the light pulse PO and projected to the subject OB.

The light receiver 3 receives reflected light RL of the light pulse PO reflected off the subject OB the distance to which will be measured by the range imaging apparatus 1 and outputs a pixel signal corresponding to the received reflected light RL. The light receiver 3 includes a lens 31 and a range image sensor 32.

The lens 31 is an optical lens that introduces the reflected light RL that is incident on the lens 31 to the range image sensor 32. The lens 31 outputs the reflected light RL that is incident on the lens 31 toward the range image sensor 32 and causes pixels provided in a light-receiving region of the range image sensor 32 to receive the reflected light RL (or makes the reflected light RL incident on the pixels).

The range image sensor 32 is an imaging device used in the range imaging apparatus 1. The range image sensor 32 includes multiple pixels in a two-dimensional light-receiving region. Each pixel of the range image sensor 32 includes a photoelectric conversion device, multiple charge accumulators corresponding to the single photoelectric conversion device, and a component that distributes electric charge to each charge accumulator. That is, the pixels are imaging elements of a distributing structure that distributes and stores the electric charge to the charge accumulators.

The range image sensor 32 distributes the electric charge generated by the photoelectric conversion device to each charge accumulator in response to the control procedure performed by the timing control section 41. Additionally, the range image sensor 32 outputs a pixel signal corresponding to the amount of charge distributed to each charge accumulator. The range image sensor 32 includes multiple pixels arranged in a two-dimensional matrix and outputs a pixel signal for one frame corresponding to each pixel.

The range image processor 4 controls the range imaging apparatus 1 to compute the distance to the subject OB. The range image processor 4 includes the timing control section 41, a range computing section 42, a measurement control section 43, and a storage 44. Note that, some of the functional sections of the range image processor 4 (the timing control section 41, the range computing section 42, the measurement control section 43, and the storage 44) may be incorporated in the range image sensor 32.

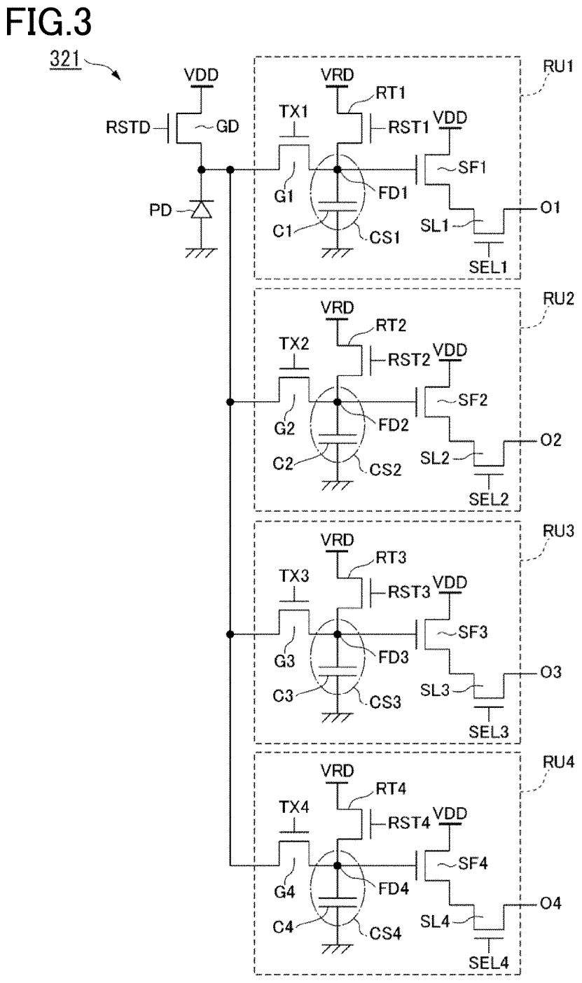

The timing control section 41 controls the points in time at which a variety of control signals required for the measurement are output in response to the control procedure performed by the measurement control section 43. The variety of signals as used herein refer to, for example, a signal for controlling the emission of the light pulse PO, a signal for distributing and accumulating the reflected light RL to the charge accumulators, and a signal for controlling the number of times of distribution (number of times of accumulation) per one frame. The number of times of distribution is the number of times the process of distributing the electric charge to charge accumulators CS (refer to FIG. 3) is repeated.

The range computing section 42 calculates the distance to the subject OB using the pixel signals output from the range image sensor 32 and waveform information 440, which will be described later, and outputs the calculated range information. The range computing section 42 corrects the amounts of charge accumulated in the charge accumulators obtained from the pixel signals output from the range image sensor 32 using the waveform information 440 and computes the distance to the subject OB based on the corrected charge amounts. The waveform information 440 will be described below in detail. A method used by the range computing section 42 for determining the distance to the subject OB using the waveform information 440 will also be described below in detail.

The measurement control section 43 controls the timing control section 41. For example, the measurement control section 43 sets, for example, the number of times of distribution in one frame and an accumulation time Ta and controls the timing control section 41 so that the image is picked up according to the settings.

The storage 44 is constituted by a storage medium such as hard disk drive (HDD), a flash memory, an electrically erasable programmable read only memory (EEPROM), a random access read/write memory (RAM), a read only memory (ROM), or any combination of these storage media. The storage 44 stores, for example, the waveform information 440.

With this configuration, the range imaging apparatus 1 causes the light source unit 2 to emit the light pulse PO in the near-infrared wavelength band to the subject OB, causes the light receiver 3 to receive the reflected light RL reflected off the subject OB, and causes the range image processor 4 to measure the distance to the subject OB and output as the range information.

Note that, although FIG. 1 illustrates a range imaging apparatus 1 internally including the range image processor 4, the range image processor 4 may be a component externally to the range imaging apparatus 1.

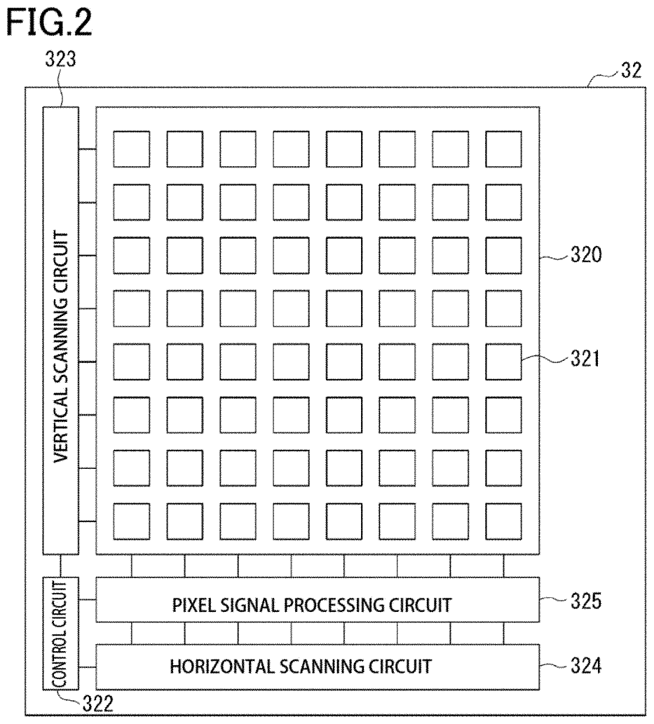

Next, the configuration of the range image sensor 32 used as the imaging device in the range imaging apparatus 1 will be described. FIG. 2 is a block diagram illustrating the schematic configuration of the imaging device (range image sensor 32) used in the range imaging apparatus 1 of the embodiment.

As illustrated in FIG. 2, the range image sensor 32 includes, for example, a light-receiving region 320, which includes multiple pixels 321, a control circuit 322, a vertical scanning circuit 323, which has distribution operation, a horizontal scanning circuit 324, and a pixel signal processing circuit 325.

The light-receiving region 320 is a region in which the pixels 321 are arranged. FIG. 2 illustrates an example in which the pixels 321 are arranged in a two-dimensional matrix of 8 rows and 8 columns. The pixels 321 accumulate electric charge corresponding to the quantity of light received. The control circuit 322 comprehensively controls the range image sensor 32. The control circuit 322 controls the operation of the components of the range image sensor 32 in response to, for example, the instruction from the timing control section 41 of the range image processor 4. Note that, the components of the range image sensor 32 may be directly controlled by the timing control section 41. In this case, the control circuit 322 may be omitted.

The vertical scanning circuit 323 is a circuit that controls the pixels 321 arranged in the light-receiving region 320 row by row in response to the control procedure performed by the control circuit 322. The vertical scanning circuit 323 causes the pixel signal processing circuit 325 to output a voltage signal corresponding to the amount of charge accumulated in each of the charge accumulators CS of each pixel 321. In this case, the vertical scanning circuit 323 distributes the electric charge converted by the photoelectric conversion device to each of the charge accumulators of each pixel 321. That is, the vertical scanning circuit 323 is an example of a “pixel driver circuit”.

The pixel signal processing circuit 325 is a circuit that performs predetermined signal processing (for example, noise suppression and A/D conversion) on voltage signals output from the pixels 321 of each column to a corresponding vertical signal line in response to the control procedure performed by the control circuit 322.

The horizontal scanning circuit 324 is a circuit that sequentially outputs, to a horizontal signal line, the signal output from the pixel signal processing circuit 325 in response to the control procedure performed by the control circuit 322. Accordingly, the pixel signal corresponding to the amount of charge accumulated for one frame is sequentially output to the range image processor 4 via the horizontal signal line.

The following description is based on a precondition that the pixel signal processing circuit 325 has performed A/D conversion, so that the pixel signal is a digital signal.

The configuration of the pixels 321 arranged in the light-receiving region 320 of the range image sensor 32 will now be described. FIG. 3 is a circuit diagram illustrating an exemplary configuration of the pixels 321 arranged in the light-receiving region 320 of the range image sensor 32 according to the embodiment. FIG. 3 illustrates an exemplary configuration of one of the pixels 321 arranged in the light-receiving region 320. The drawing illustrates an exemplary configuration in which the pixel 321 includes four pixel signal readout units.

As illustrated in FIG. 3, the pixel 321 includes one photoelectric conversion device PD, a drain-gate transistor GD, and four pixel signal readout units RU (pixel signal readout units RU1 to RU4). Each pixel signal readout unit RU outputs a voltage signal through an output terminal O.

In the following description, a numerical value “1”, “2”, “3”, or “4” is appended after the reference sign RU of the four pixel signal readout units to distinguish the pixel signal readout units RU from one another. Similarly, the numerical values are also appended after the reference signs of the components of the four pixel signal readout units RU to distinguish the components from one another.

The pixel signal readout units RU each include a readout gate transistor G, a floating diffusion FD, a charge accumulation capacitor C, a reset gate transistor RT, a source follower gate transistor SF, and a selection gate transistor SL. In each pixel signal readout unit RU, the floating diffusion FD and the charge accumulation capacitor C constitute the charge accumulator CS. Specifically, the pixel signal readout unit RU1 includes a readout gate transistor G1, a floating diffusion FD1, a charge accumulation capacitor C1, a reset gate transistor RT1, a source follower gate transistor SF1, and a selection gate transistor SL1. In the pixel signal readout unit RU1, the floating diffusion FD1 and the charge accumulation capacitor C1 constitute the charge accumulator CS1. The pixel signal readout units RU2 to RU4 also have the same configuration.

The photoelectric conversion device PD is an embedded photodiode that performs photoelectric conversion of the incident light to generate electric charge and accumulates the generated electric charge. The photoelectric conversion device PD may have any configuration. The photoelectric conversion device PD may be, for example, a PN photodiode including a P-type semiconductor and an N-type semiconductor joined together or a PIN photodiode including an I-type semiconductor sandwiched between a P-type semiconductor and an N-type semiconductor. Alternatively, the photoelectric conversion device PD is not limited to a photodiode and may be, for example, a photogate-type photoelectric conversion device.

In each pixel 321, the electric charge generated by the photoelectric conversion of the incident light performed by the photoelectric conversion device PD is distributed to each of four charge accumulators CS. A voltage signal corresponding to the charge amount of the distributed electric charge is output to the pixel signal processing circuit 325.

The configuration of the pixels arranged in the range image sensor 32 is not limited to the configuration including four pixel signal readout units RU as illustrated in FIG. 3 and may be any configuration including multiple pixel signal readout units RU. That is, the number of the pixel signal readout units RU (charge accumulators CS) included in each pixel located in the range image sensor 32 may be two, three, or five or more.

Furthermore, the pixel 321 configured as illustrated in FIG. 3 shows an exemplary configuration in which each charge accumulator CS includes the floating diffusion FD and the charge accumulation capacitor C. However, each charge accumulator CS may have any configuration as long as at least the floating diffusion FD is included, and each pixel 321 does not need to include the charge accumulation capacitor C.

Furthermore, the pixel 321 configured as illustrated in FIG. 3 shows an exemplary configuration including the drain gate transistor GD, but the embodiment is not limited to this configuration. For example, the drain gate transistor GD may be omitted if there is no need to drain the electric charge that is not accumulated in the charge accumulators CS and remains in the photoelectric conversion device PD.

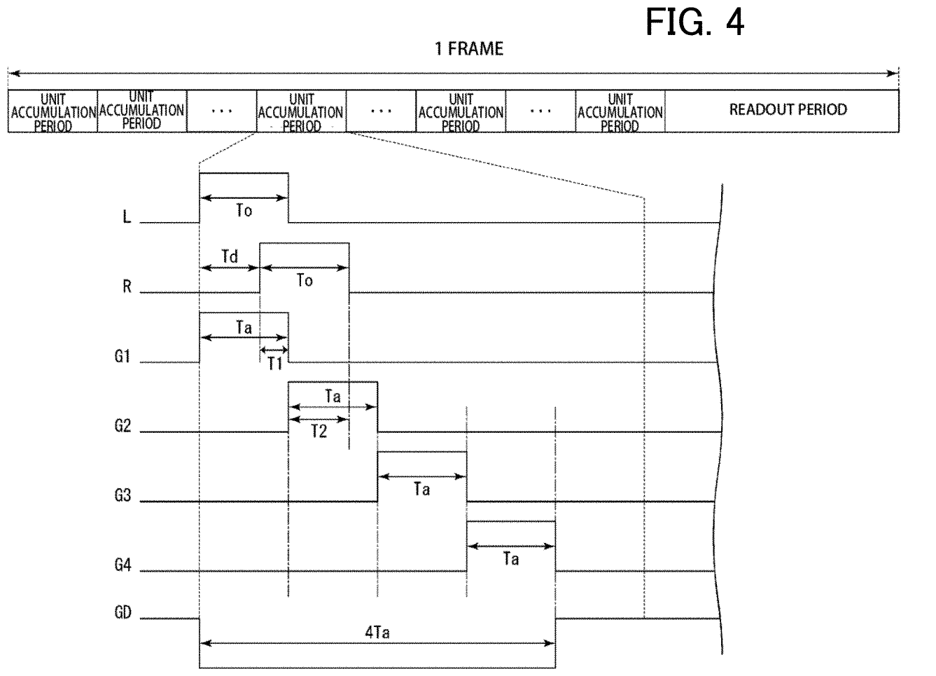

Next, the points in time at which each pixel 321 is driven will be described using FIG. 4. FIG. 4 is a timing diagram illustrating points in time at which each pixel 321 of the embodiment is driven.

FIG. 4 shows the time required for accumulating the electric charge to each of the charge accumulators CS in one distribution process as a “unit accumulation period”. After repeatedly performing the distribution process conducted in the “unit accumulation period” for the number of times of accumulation corresponding to one frame, a process of reading out the amount of charge accumulated during this period is performed. The time during which the accumulated charge amount is read out is indicated as a “readout period”.

In FIG. 4, the point in time at which the light pulse PO is emitted is indicated by the symbol “L”, the point in time at which the reflected light RL is received is indicated by the symbol “R”, the point in time at which the readout gate transistor G1 is driven is indicated by the symbol “G1”, the point in time at which the readout gate transistor G2 is driven is indicated by the symbol “G2”, the point in time at which the readout gate transistor G3 is driven is indicated by the symbol “G3”, the point in time at which the readout gate transistor G4 is driven is indicated by the symbol “G4”, and the point in time at which the drive signal RSTD is given is indicated by the symbol “GD”.

The vertical scanning circuit 323 accumulates the electric charge in the charge accumulators CS1 to CS4 at the points in time synchronized with the emission of the light pulse PO. In the example of FIG. 4, the electric charge is accumulated in the charge accumulator CS1 at the point in time that is the same as the point in time at which the light pulse PO is emitted. After accumulating the electric charge in the charge accumulator CS1, the electric charge is sequentially accumulated in the charge accumulators CS2 to CS4.

The example of FIG. 4 shows the timing diagram of a case in which the range image sensor 32 receives the reflected light RL after a delay time Td from the time at which the light pulse PO is emitted. The electric charge corresponding to the reflected light RL is distributed to and accumulated in the charge accumulators CS1 and CS2 or the charge accumulators CS2 and CS3 depending on the delay time Td. At the point in time at which the charge accumulator CS4 accumulates the electric charge, no reflected light RL is received, and the electric charge corresponding to an external light component such as background light is accumulated in the charge accumulator CS4.

Specifically, first, the vertical scanning circuit 323 causes the light pulse PO to be emitted. At the point in time that is the same as the point in time of the light emission, the vertical scanning circuit 323 brings the drain gate transistor GD into an off state and brings the readout gate transistor G1 into an on state for the accumulation time Ta. After keeping the readout gate transistor G1 in the on state for the accumulation time Ta, the vertical scanning circuit 323 brings the readout gate transistor G1 into the off state. Thus, while the readout gate transistor G1 is controlled to be in the on state, the electric charge obtained by the photoelectric conversion by the photoelectric conversion device PD is accumulated in the charge accumulator CS1 through the readout gate transistor G1.

Next, at the point in time at which the readout gate transistor G1 is brought into the off state, the vertical scanning circuit 323 brings the readout gate transistor G2 into the on state for the accumulation time Ta. After keeping the readout gate transistor G2 in the on state for the accumulation time Ta, the vertical scanning circuit 323 brings the readout gate transistor G2 into the off state. Thus, while the readout gate transistor G2 is controlled to be in the on state, the electric charge obtained by the photoelectric conversion by the photoelectric conversion device PD is accumulated in the charge accumulator CS2 through the readout gate transistor G2.

Next, at the point in time at which the readout gate transistor G2 is brought into the off state, the vertical scanning circuit 323 brings the readout gate transistor G3 into the on state for the accumulation time Ta. After keeping the readout gate transistor G3 in the on state for the accumulation time Ta, the vertical scanning circuit 323 brings the readout gate transistor G3 into the off state. Thus, while the readout gate transistor G3 is controlled to be in the on state, the electric charge obtained by the photoelectric conversion by the photoelectric conversion device PD is accumulated in the charge accumulator CS3 through the readout gate transistor G3.

Next, at the point in time at which the accumulation of the electric charge to the charge accumulator CS3 is finished, the vertical scanning circuit 323 brings the readout gate transistor G4 into the on state for the accumulation time Ta. After keeping the readout gate transistor G4 in the on state for the accumulation time Ta, the vertical scanning circuit 323 brings the readout gate transistor G4 into the off state. At the point in time at which the readout gate transistor G4 is brought into the off state, the vertical scanning circuit 323 brings the drain gate transistor GD into the on state. Bringing the drain gate transistor GD into the on state inhibits the electric charge obtained by the photoelectric conversion performed by the photoelectric conversion device PD during this period from being accumulated in the charge accumulators CS and allows the electric charge to be drained through the drain gate transistor GD.

The vertical scanning circuit 323 repeatedly performs the above-described driving processes by a predetermined number of times of distribution for one frame. Subsequently, the vertical scanning circuit 323 outputs a voltage signal corresponding to the amount of charge accumulated in each charge accumulator CS. Specifically, the vertical scanning circuit 323 brings the selection gate transistor SL1 into the on state for a predetermined time period to output a voltage signal corresponding to the amount of charge accumulated in the charge accumulator CS1 through the pixel signal readout unit RU1 from an output terminal O1. Similarly, the vertical scanning circuit 323 sequentially brings the selection gate transistors SL2 to SL4 into the on state to output voltage signals corresponding to the amounts of charge accumulated in the charge accumulators CS2 to CS4 through output terminals O2 to O4. Thus, electric signals corresponding to the amounts of charge for one frame accumulated in the respective charge accumulators CS are output to the range computing section 42.

Note that the above description exemplifies a case in which the readout gate transistor G1 is brought into the on state at the point in time at which the light pulse PO is emitted. However, the embodiment is not limited to this configuration. The light pulse PO only needs to be emitted at the point in time at which the electric charge corresponding to the reflected light RL is distributed and accumulated in at least the charge accumulators CS1 and CS2 or CS2 and CS3.

In FIG. 4, based on the relationship between the point in time at which the light pulse PO is emitted and the points in time at which the electric charge is accumulated in each of the charge accumulators CS, the charge amounts corresponding to the reflected light RL and the external light component are distributed and held in the charge accumulators CS1 and CS2. In this case, the charge accumulator CS1 is an example of a “first charge accumulator”. The charge accumulator CS2 is an example of a “second charge accumulator”. Additionally, the charge amount corresponding to the external light component such as the background light is held in the charge accumulator CS4. In this case, the charge accumulator CS4 is an example of an “external light charge accumulator”.

Note that, when the reflected light RL from the subject OB that is located relatively far away is received, the delay dime Td is increased. As a result, the charge corresponding to the reflected light RL and the external light component is distributed and held in the charge accumulators CS2 and CS3. In this case, the charge accumulator CS2 is an example of the “first charge accumulator”. The charge accumulator CS3 is an example of the “second charge accumulator”.

The allocation (distribution ratio) of the amount of charge distributed to the charge accumulators CS1 and CS2 will be in a ratio according to the delay time Td until the light pulse PO is reflected by the subject OB and received by the range imaging apparatus 1.

The range computing section 42 calculates the delay time Td by the following equation (1) using this principle. In equation (1), To represents the time span during which the light pulse

PO is emitted, and R represents the charge ratio indicating the distribution ratio of the reflected light RL.

Td=To×R (1)

Where

R=Q2#/(Q1#+Q2#)

Q1#=Q1−Qb

Q2#=Q2−Qb

Q4=Qb

To represents the time span during which the light pulse PO is emitted.

R represents the charge ratio obtained as follows.

Q1# represents the amount of charge corresponding to the reflected light RL accumulated in the charge accumulator CS1.

Q2# represents the amount of charge corresponding to the reflected light RL accumulated in the charge accumulator CS2.

Qb represents the amount of charge corresponding to the external light component accumulated in the charge accumulator CS.

Q1 represents the amount of charge accumulated in the charge accumulator CS1.

Q2 represents the amount of charge accumulated in the charge accumulator CS2.

Q4 represents the amount of charge accumulated in the charge accumulator CS4.

The range computing section 42 calculates the round-trip distance to the subject OB by multiplying the delay time Td obtained using equation (1) by the speed of light (speed) in the short-range light-receiving pixel. The range computing section 42 obtains the distance to the subject OB by halving the round-trip distance calculated above.

The factors that cause an error in the distance (measurement distance) calculated based on the accumulated charge amount will now be described.

One factor that causes the error may be that waveform distortion occurs in a rectangular signal used for various types of signal processing involved in the measurement of the distance. In the actual circuit, the high-frequency properties in signal transmission deteriorate due to, for example, wiring resistance or parasitic capacitance. Additionally, a delay occurs during charge transfer. The deterioration of the high-frequency properties or the charge transfer efficiency in the photoelectric conversion device PD causes a delay when the signal amplitude rapidly changes such as at the rising edge and the falling edge of the signal and results in the occurrence of waveform distortion. As a result, distortion of the rectangular shape occurs, and the waveform is changed in such a manner that the rising edge is delayed and the falling edge is delayed.

Distortion in the rectangular signal used in a variety of processes for measuring the distance causes errors. For example, when distortion occurs in the timing signal of the driver controlling the laser diode that emits the light pulse, a specified light quantity is achieved after a slight delay following the emission of the light pulse, and the light quantity of the light pulse PO becomes 0 (zero) after a slight delay following the stopping of the emission. Since such waveform distortion affects the reflected light RL, the reflected light RL is also received by the pixel 321 in a tailing waveform. Furthermore, when distortion occurs in the timing signal of the readout gate transistor G, the charge amount that is supposed to be accumulated in the charge accumulator CS1 may be accumulated in the charge accumulator CS2, or the charge amount that is supposed to be accumulated in the charge accumulator CS2 may be accumulated in the charge accumulator CS3. The delay time Td calculated by equation (1) using the charge amount accumulated in the charge accumulator CS that is different from the charge accumulator CS to which the charge amount should have been accumulated as described above is a value different from the actual delay time Td and includes errors.

As a countermeasure against this, in the present embodiment, the amount of charge corresponding to the reflected light RL accumulated in each of the charge accumulators CS is corrected, using the waveform information 440, to the charge amount which would have been accumulated in a case in which a rectangular signal without waveform distortion was used. The waveform information 440 is the information indicating the distortion degree of the waveform. The delay time Td is calculated by equation (1) using the corrected charge amounts. This reduces the errors caused due to the distortion of the rectangular signal.

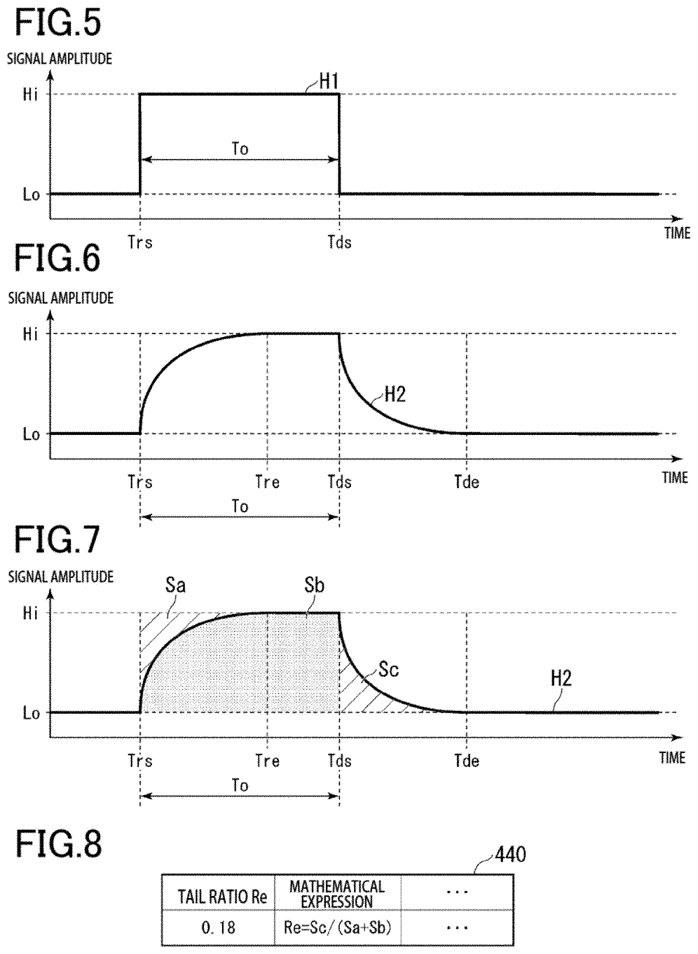

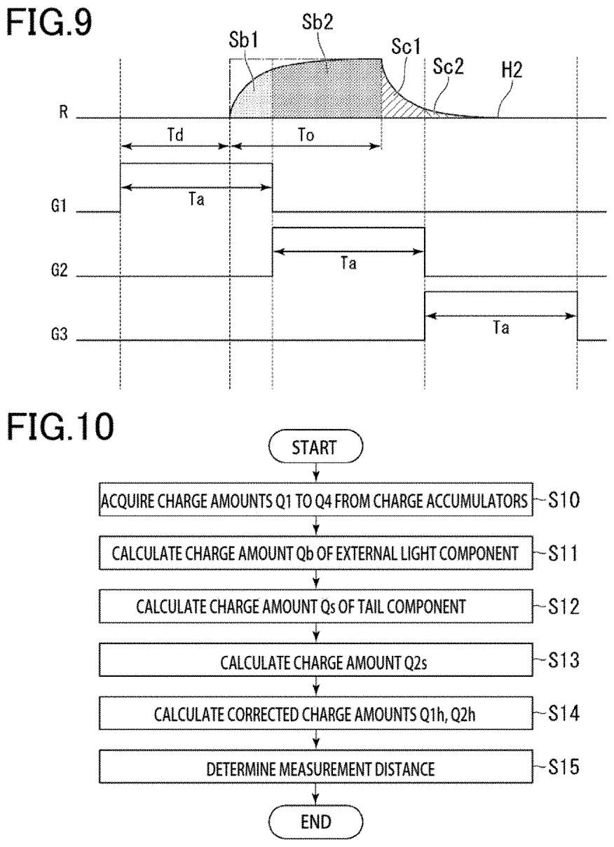

A method for correcting the charge amounts will now be specifically described with reference to FIGS. 5 to 9. FIGS. 5 to 7 are diagrams illustrating waveform distortion according to the embodiment. FIG. 8 is a table illustrating an exemplary configuration of the waveform information 440 according to the embodiment. FIG. 9 is a diagram illustrating a process of correcting the charge amounts performed by the range image processor 4 according to the embodiment.

FIG. 5 schematically illustrates a rectangular signal H1 without waveform distortion (hereinafter, also referred to as the “rectangular signal H1”). As illustrated in FIG. 5, the signal amplitude of the signal H1 changes from Lo to Hi at a rising start time Trs and changes from Hi to Lo at a falling start time Tds.

FIG. 6 schematically illustrates a tailing signal H2 with waveform distortion (hereinafter also referred to as the “tailing signal H2”). As illustrated in FIG. 6, the signal amplitude of the signal H2 gradually changes from Lo to Hi during the time period from the rising start time Trs to a rising end time Tre. Additionally, the signal amplitude of the signal H2 gradually changes from Hi to Lo during the time period from the falling start time Tds to a falling end time Tde.

FIG. 7 schematically illustrates a diagram in which the waveform of the tailing signal H2 in FIG. 6 is divided into multiple regions. In the present embodiment, as illustrated in FIG. 7, the tailing signal H2 is divided into regions Sa to Sc in accordance with its waveform. The distortion degree of the tailing signal H2 is defined using the area of each region.

The region Sa corresponds to a region generated by the decrease in the amplitude due to the delay in the rising of the tailing signal H2. The area of the region Sa is an integrated value obtained by integrating the subtracted value obtained by subtracting the tailing signal H2 from the rectangular signal H1 from the rising start time Trs to the rising end time Tre.

The region Sb corresponds to a region obtained by subtracting the region Sa from a rectangular area of the rectangular signal H1. The area of the region Sb is an integrated value obtained by integrating the tailing signal H2 from the rising start time Trs to the falling start time Tds. Alternatively, the area of the region Sb is an area obtained by subtracting the area of the region Sa from the integrated value (rectangular area) obtained by integrating the rectangular signal H1 from the rising start time Trs to the falling start time Tds.

The region Sc corresponds to a tailing region generated by the delay in the falling of the tailing signal H2. The area of the region Sc is an integrated value obtained by integrating the tailing signal H2 from the falling start time Tds to the falling end time Tde.

In the present embodiment, the ratio of the tail area (the region Sc) to the rectangular area (the region Sa+Sb) is referred to as a tail ratio Re and is used as an index indicating the “distortion degree” of the waveform. Note that the tail ratio Re may be any value that at least indicates the “distortion degree” of the waveform and may be, for example, the ratio of the rectangular area (the region Sa+Sb) to the tail area (region Sc).

FIG. 8 illustrates an exemplary configuration of the waveform information 440. The waveform information 440 includes items such as the tail ratio Re, a mathematical expression, and remarks. The tail ratio Re is the index indicating the “distortion degree” of the waveform and is the ratio of the tail area (the region Sc) to the rectangular area (the region Sa+Sb). The mathematical expression is for calculating the tail ratio Re.

In the present embodiment, the distortion of each of the various types of signal processing is collected to the reflected light RL, and correction is performed assuming that the reflected light RL with distortion has been received. That is, the electric charge corresponding to the reflected light RL with distortion is accumulated in the charge accumulators CS at the points in time the readout gate transistors G are driven without distortion. The charge amounts accumulated in the charge accumulators CS are corrected based on the tail ratio Re (distortion degree) of the reflected light RL. The corrected charge amounts will be equal to the charge amount when the electric charge corresponding to the reflected light RL without distortion is accumulated in the charge accumulators CS at the points in time at which the readout gate transistors G are driven without distortion.

FIG. 9 is a diagram illustrating a process of correcting the charge amounts performed by the range image processor 4. As illustrated in FIG. 9, the present embodiment assumes a case in which the reflected light RL with distortion is accumulated in the charge accumulators CS at the points in time at which the readout gate transistors G are driven without distortion.

In FIG. 9, as in FIG. 4, the reflected light RL reaches the range image sensor 32 after the delay time Td, and the charge amount corresponding to the reflected light RL is distributed and accumulated in the charge accumulators CS1 and CS2. Additionally, in FIG. 9, since the waveform of the reflected light RL is distorted, the electric charge corresponding to the part of the reflected light RL generated by the distortion is accumulated in the charge accumulator CS3. In this case, the charge accumulator CS1 is an example of the “first charge accumulator”. The charge accumulator CS2 is an example of the “second charge accumulator”. The charge accumulator CS3 is an example of a “third charge accumulator”.

Specifically, of the reflected light RL formed by the tailing signal H2 with waveform distortion, the charge amount corresponding to part (region Sb1) of the region Sb is accumulated in the charge accumulator CS1. The charge amount corresponding to the remaining part (region Sb2) of the region Sb is accumulated in the charge accumulator CS2. The charge amount corresponding to part (region Sc1) of the region Sc is accumulated in the charge accumulator CS2. The charge amount corresponding to the remaining part (region Sc2) of the region Sc is accumulated in the charge accumulator CS3.

In correcting the charge amounts, the present embodiment is based on the premise that an emission time To during which the light pulse PO is emitted and the accumulation time Ta during which the electric charge is accumulated in each charge accumulator CS have an equal time span. In the present embodiment, for calculation purposes, the area of the region Sa and the area of the region Sc are calculated as the same value.

Note that, in FIG. 9, a timing diagram of “G4” is omitted. However, the readout gate transistor G4 is driven as in FIG. 4, and the charge amount corresponding to the external light component is accumulated in the charge accumulator CS4.

The range computing section 42 acquires an electric signal corresponding to the charge amount for one frame accumulated in each charge accumulator CS. The range computing section 42 calculates the total amount QSUM of the electric charge corresponding to the reflected light RL by the following equation (2). Here, the charge amount Q1# is a charge amount corresponding to the reflected light RL accumulated in the charge accumulator CS1 and is an example of a “first range computation charge amount”. The charge amount Q2# is a charge amount corresponding to the reflected light RL accumulated in the charge accumulator CS2 and is an example of a “second range computation charge amount”. A charge amount Q3# is a charge amount corresponding to the reflected light RL accumulated in the charge accumulator CS3 and is an example of a “third range computation charge amount”.

QSUM=Q1#+Q2#+Q3#

Q1#=Q1−Qb

Q2#=Q2−Qb

Q3#=Q3−Qb

Q4=Qb (2)

Where

Q1# represents the amount of charge corresponding to the reflected light RL accumulated in the charge accumulator CS1.

Q2# represents the amount of charge corresponding to the reflected light RL accumulated in the charge accumulator CS2.

Q3# represents the charge amount corresponding to the reflected light RL accumulated in the charge accumulator CS3.

Qb represents the amount of charge corresponding to the external light component accumulated in the charge accumulator CS.

Q1 represents the amount of charge accumulated in the charge accumulator CS1.

Q2 represents the amount of charge accumulated in the charge accumulator CS2.

Q3 represents the amount of charge accumulated in the charge accumulator CS3.

Q4 represents the amount of charge accumulated in the charge accumulator CS4.

The range computing section 42 calculates a charge amount Qs (charge amount corresponding to the region Sc in FIG. 7) of the tailing section by the following equation (3) using the total amount QSUM of the electric charge calculated by equation (2) and the tail ratio Re stored in the waveform information 440.

Qs=QSUM×Re (3)

Where

QSUM=Q1#+Q2#+Q3#

Q1# represents the amount of charge corresponding to the reflected light RL accumulated in the charge accumulator CS1.

Q2# represents the amount of charge corresponding to the reflected light RL accumulated in the charge accumulator CS2.

Q3190 represents the charge amount corresponding to the reflected light RL accumulated in the charge accumulator CS3.

Re represents the tail ratio.

The range computing section 42 divides the charge amount Qs of the tailing section calculated by equation (3) into a charge amount Q2s accumulated in the charge accumulator CS2 and the charge amount Q3# corresponding to the reflected light RL accumulated in the charge accumulator CS3 by equation (4).

Qs=Q2s+Q3# (4)

Where

Q2s represents the amount of charge corresponding to the tailing section of the reflected light RL accumulated in the charge accumulator CS2.

Q3# represents the amount of charge corresponding to the reflected light RL accumulated in the charge accumulator CS3.

The range computing section 42 calculates the charge amount Q2s in equation (4). Since the charge amount Qs of the tailing section and the charge amount Q3# corresponding to the reflected light RL accumulated in the charge accumulator CS3 are known, the charge amount Q2s is calculated by equation (5).

Q2s=Qs−Q3# (5)

Where

Q2s represents the amount of charge corresponding to the tailing section of the reflected light RL accumulated in the charge accumulator CS2.

Q3# represents the amount of charge corresponding to the reflected light RL accumulated in the charge accumulator CS3.

Qs represents the charge amount of the tailing section.

The range computing section 42 calculates a corrected charge amount Q1h by correcting the charge amount Q1# as in equation (6) based on the premise that the area of the region Sa is equal to the area of the region Sc. The range computing section 42 calculates a corrected charge amount Q2h by correcting the charge amount Q2# as in equation (7).

Q1h=Q1#+Q2s (6)

Q2h=Q2#Q2s+Q3# (7)

Where

Q1h represents the amount of charge corresponding to the reflected light RL accumulated in the charge accumulator CS1 after correction.

Q1# represents the amount of charge corresponding to the reflected light RL accumulated in the charge accumulator CS1 before correction.

Q2s represents the amount of charge corresponding to the tailing section of the reflected light RL accumulated in the charge accumulator CS2.

Q2h represents the amount of charge corresponding to the reflected light RL accumulated in the charge accumulator CS2 after correction.

Q2# represents the amount of charge corresponding to the reflected light RL accumulated in the charge accumulator CS2 before correction.

Q3# represents the amount of charge corresponding to the reflected light RL accumulated in the charge accumulator CS3.

FIG. 10 is a flowchart illustrating a process flow performed by the range image processor according to the embodiment. The range computing section 42 acquires the charge amounts Q1 to Q4 respectively accumulated in the charge accumulators CS1 to CS4 (step S10). The range computing section 42 calculates the charge amount Qb corresponding to the external light component using the acquired charge amount Q4 (step S11).

The range computing section 42 calculates the charge amount Qs corresponding to the tailing component using the charge amounts Q1 to Q3, the charge amount Qb, and the tail ratio Re (step S12). The range computing section 42 calculates the charge amount Qs by substituting the charge amounts Q1 to Q3, the charge amount Qb, and the tail ratio Re into equation (2) and equation (3).

The range computing section 42 calculates, of the charge amount corresponding to the tailing component, the charge amount Q2s accumulated in the charge accumulator CS2 (step S13). The range computing section 42 calculates the charge amount Q2s using equation (4) and equation (5). The range computing section 42 calculates the corrected charge amount Q1h by correcting the charge amount Q1# and calculates the corrected charge amount Q2h by correcting the charge amount Q2# (step S14). The range computing section 42 determines the measurement distance using the corrected charge amounts Q1h and Q2h (step S15). The range computing section 42 calculates the delay time Td by substituting the corrected charge amount Q1h into the charge amount Q1# in equation (1) and the corrected charge amount Q2h into the charge amount Q2# in equation (1). The range computing section 42 calculates the measurement distance by multiplying the calculated delay time Td by the speed of light (speed) and then halving the multiplication value.

Note that the above description exemplifies a case in which each pixel 321 of the range imaging apparatus 1 includes four charge accumulators CS1 to CS4. However, the embodiment is not limited to this configuration. Each pixel 321 of the range imaging apparatus 1 may include five or more charge accumulators CS (the number of which may be, for example, N, where N≥5).

When each pixel 321 of the range imaging apparatus 1 includes the charge accumulators CS the number of which is N (N≥5), at step S10, the range computing section 42 acquires the charge amounts Q1 to QN respectively accumulated in the charge accumulators CS1 to CSN. At step S11, the range computing section 42 calculates the charge amount Qb corresponding to the external light component using the acquired charge amounts Q1 to QN. A method by which the range computing section 42 calculates the charge amount Qb includes using the charge amount accumulated in the charge accumulator CS at a point in time when no reflected light RL is received in the same manner as the case in which each pixel 321 of the range imaging apparatus 1 includes four charge accumulators CS1 to CS4.

At step S12, the range computing section 42 selects, among the charge accumulators CS1 to CSN, three charge accumulators CS to which the electric charge corresponding to the reflected light RL (including the tailing section) has been distributed and accumulated. A method used by the range computing section 42 to select three charge accumulators CS includes, for example, among the combinations of three charge accumulators CS in which the electric charge is successively accumulated, the combination of the charge accumulators CS that gives the greatest sum of the charge amounts accumulated in the respective charge accumulators CS is selected as the three charge accumulators CS to which the electric charge corresponding to the reflected light

RL is distributed and accumulated. The range computing section 42 calculates the charge amount Qs using the charge amounts accumulated in the three charge accumulators CS in which the electric charge corresponding to the reflected light RL has been distributed and accumulated and the charge amount Qb corresponding to the external light component. Processes of steps S13 to S15 are the same as the case in which each pixel 321 of the range imaging apparatus 1 includes four charge accumulators CS1 to CS4.

Alternatively, each pixel 321 of the range imaging apparatus 1 may include three charge accumulators CS1 to CS3. In this case, the range imaging apparatus 1 performs two charge accumulation processes per single measurement. The two charge accumulation processes include a process of accumulating only the electric charge corresponding to the external light component (referred to as a first process) and a process of accumulating the electric charge including the reflected light RL (referred to as a second process). For example, the range imaging apparatus 1 performs the first process in the first frame and the second process in the next frame. In performing the first process, the range imaging apparatus 1 accumulates the electric charge in each of the charge accumulators CS1 to CS3 without emitting the light pulse PO. In performing the second process, the range imaging apparatus 1 emits the light pulse PO and accumulates the electric charge in each of the charge accumulators CS1 to CS3.

In this case, at step S10, the range computing section 42 acquires charge amounts Q1ft to Q3ft respectively accumulated in the charge accumulators CS1 to CS3 in the first process. Additionally, the range computing section 42 acquires charge amounts Q1sd to Q3sd respectively accumulated in the charge accumulators CS1 to CS3 in the second process. At step S11, the range computing section 42 sets one of the acquired charge amounts Q1ft to Q3ft or a combination thereof as the charge amount Qb corresponding to the external light component. At step S12, the range computing section 42 calculates the charge amount Q2s using the acquired charge amounts Q1sd to Q3sd and the charge amount Qb. A method by which the range computing section 42 calculates the charge amount Q2s is the same as the case in which each pixel 321 of the range imaging apparatus 1 includes four charge accumulators CS1 to CS4.

### Modification of Embodiment

A modification of the embodiment will now be described. Like the embodiment described above, the present modification is based on the premise that the reflected light RL with waveform distortion is received, but differs from the embodiment described above in that the electric charge corresponding to the tailing section of the reflected light RL generated by the distortion is accumulated in the charge accumulator CS2.

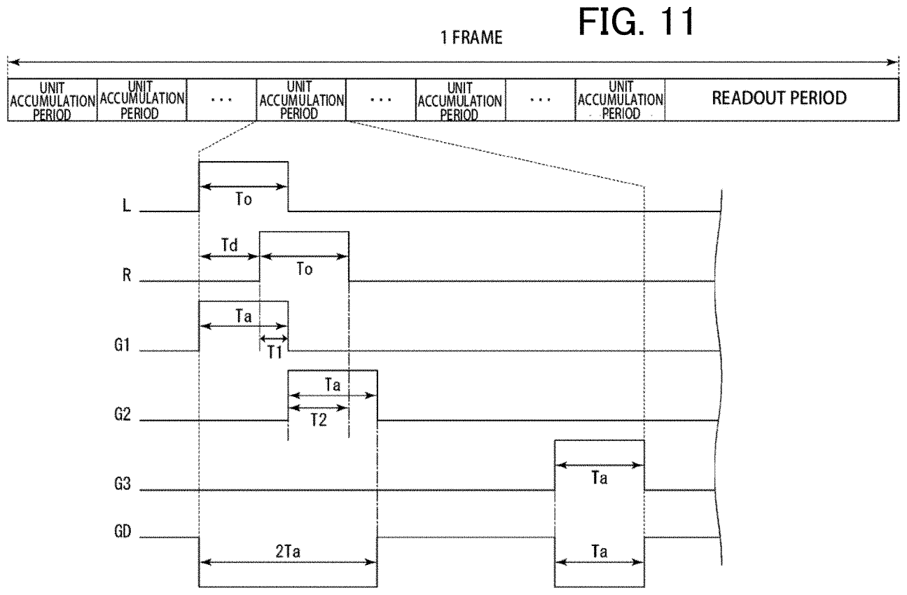

FIG. 11 is a timing diagram illustrating an example of points in time at which each pixel 321 according to the modification of the embodiment is driven. Since the “unit accumulation period” and the “readout period” in FIG. 11 are the same as those in FIG. 4, their descriptions will be omitted. Additionally, since “L”, “R”, “G1” to “G3”, and “GD” in FIG. 11 are also the same as those in FIG. 4, their descriptions will be omitted.

The example in FIG. 11 shows, as in FIG. 4, the timing diagram of a case in which the range image sensor 32 receives the reflected light RL after the delay time Td from the time at which the light pulse PO is emitted. In FIG. 11, the electric charge corresponding to the reflected light RL is distributed and accumulated in the charge accumulators CS1 and CS2. At the point in time at which the charge accumulator CS3 accumulates the electric charge, no reflected light RL is received, and the electric charge corresponding to the external light component such as the background light is accumulated in the charge accumulator CS3.

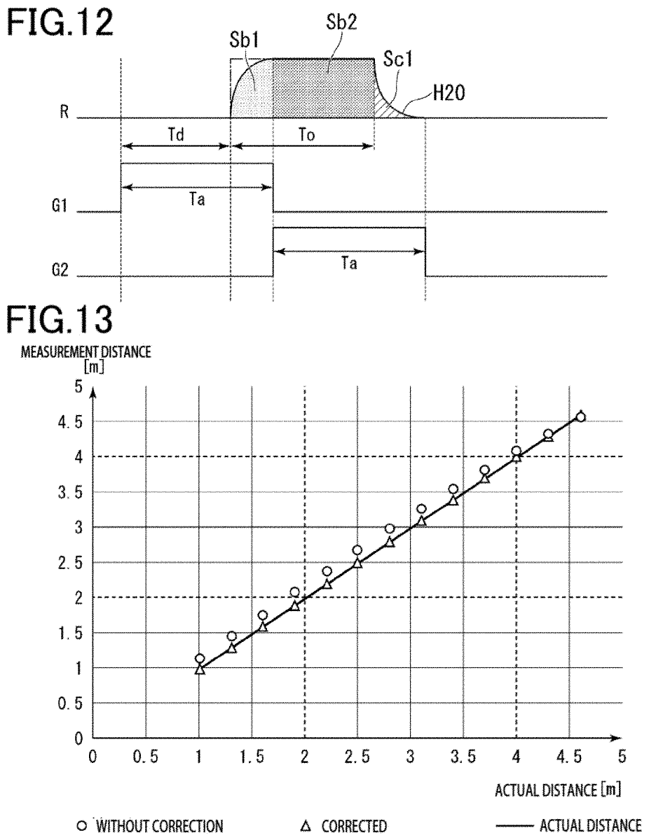

FIG. 12 is a diagram illustrating a process of correcting a charge amount performed by the range image processor 4 according to the modification of the embodiment. In FIG. 12, as in FIG. 11, the reflected light RL reaches the range image sensor 32 after the delay time Td, and the charge amount corresponding to the reflected light RL is distributed and accumulated in the charge accumulators CS1 and CS2. In this case, the charge accumulator CS1 is an example of the “first charge accumulator”. The charge accumulator CS2 is an example of the “second charge accumulator”.

Specifically, of the reflected light RL defined by the tailing signal H20 with waveform distortion, the charge amount corresponding to part (region Sb1) of the region Sb is accumulated in the charge accumulator CS1. The charge amount corresponding to the remaining part (region Sb2) of the region Sb is accumulated in the charge accumulator CS2. Additionally, the charge amount corresponding to the region Sc is accumulated in the charge accumulator CS2.

In correcting the charge amounts, like the embodiment described above, the present modification is based on the premise that the emission time To during which the light pulse PO is emitted and the accumulation time Ta during which the electric charge is accumulated in each charge accumulator CS have an equal time span. Additionally, the present modification is based on the premise that the area of the region Sa is equal to the area of the region Sc.

Note that, in FIG. 12, a timing diagram of “G3” is omitted, but the readout gate transistor G3 is driven as in FIG. 11, and the charge amount corresponding to the external light component is accumulated in the charge accumulator CS3.

The range computing section 42 acquires an electric signal corresponding to the charge amount for one frame accumulated in each charge accumulator CS. The range computing section 42 calculates the total amount QSUM of the electric charge corresponding to the reflected light RL by the following equation (8).

QSUM=Q1#+Q2#

Q1#=Q1−Qb

Q2#=2−Qb

Q3=Qb (8)

Where

Q1# represents the amount of charge corresponding to the reflected light RL accumulated in the charge accumulator CS1.

Q2# represents the amount of charge corresponding to the reflected light RL accumulated in the charge accumulator CS2.

Qb represents the amount of charge corresponding to the external light component accumulated in the charge accumulator CS.

Q1represents the amount of charge accumulated in the charge accumulator CS1.

Q2 represents the amount of charge accumulated in the charge accumulator CS2.

Q3 represents the amount of charge accumulated in the charge accumulator CS3.

The range computing section 42 calculates the charge amount Qs (charge amount corresponding to the region Sc in FIG. 12) of the tailing section by the following equation (9) using the total amount QSUM of the electric charge calculated by equation (8) and the tail ratio Re stored in the waveform information 440.

Qs=QSUM×Re (9)

Where

QSUM=Q1#+Q2#

Q1#represents the amount of charge corresponding to the reflected light RL accumulated in the charge accumulator CS1.

Q2#represents the amount of charge corresponding to the reflected light RL accumulated in the charge accumulator CS2.

Re represents the tail ratio.

The range computing section 42 sets the charge amount Qs of the tailing section calculated by equation (9) as the charge amount Q2s accumulated in the charge accumulator CS2 by equation (10).

Qs=Q2s (10)

Where

Q2s represents the amount of charge corresponding to the tailing section of the reflected light RL accumulated in the charge accumulator CS2.

The range computing section 42 obtains the charge amount Q2s by equation (9). Since the charge amount Qs of the tailing section is known, the charge amount Q2s is calculated by equation (10).

Qs=Qs (10)

Where

Q2s represents the amount of charge corresponding to the tailing section of the reflected light RL accumulated in the charge accumulator CS2.

Qs represents the charge amount of the tailing section. The range computing section 42 calculates the corrected charge amount Q1h by correcting the charge amount Q1# as in equation (11) on the assumption that the area of the region Sa is equal to the area of the region Sc for calculation purposes. Additionally, the range computing section 42 calculates the corrected charge amount Q2h by correcting the charge amount Q2# as in equation (12).

Q1h=Q1#+Q2s (11)

Q2h=Q2#−Q2s (12)

Where

Q1h represents the amount of charge corresponding to the reflected light RL accumulated in the charge accumulator CS1 after correction.

Q1# represents the amount of charge corresponding to the reflected light RL accumulated in the charge accumulator CS1 before correction.

Q2s represents the amount of charge corresponding to the tailing section of the reflected light RL accumulated in the charge accumulator CS2.

Q2h represents the amount of charge corresponding to the reflected light RL accumulated in the charge accumulator CS2 after correction.

Q2# represents the amount of charge corresponding to the reflected light RL accumulated in the charge accumulator CS2 before correction.

The above description exemplifies a case in which each pixel 321 of the range imaging apparatus 1 includes three charge accumulators CS1 to CS3, and one of the charge accumulators CS1 to CS3, that is, the charge accumulator CS3 accumulates only the electric charge corresponding to the external light component. However, the embodiment is not limited to this configuration. Each pixel 321 of the range imaging apparatus 1 may include two charge accumulators CS. In this case, the range imaging apparatus 1 performs two charge accumulation processes per single measurement. The two charge accumulation processes include a process of accumulating only the electric charge corresponding to the external light component (referred to as a first process) and a process of accumulating the electric charge including the reflected light RL (referred to as a second process). For example, the range imaging apparatus 1 performs the first process in the first frame and the second process in the next frame. In performing the first process, the range imaging apparatus 1 accumulates the electric charge in each of the charge accumulators CS1 and CS2 without emitting the light pulse PO. In performing the second process, the range imaging apparatus 1 emits the light pulse PO and accumulates the electric charge in each of the charge accumulators CS1 and CS2.

In this case, at step S10, the range computing section 42 acquires the charge amounts Q1ft and Q2ft respectively accumulated in the charge accumulators CS1 and CS2 in the first process. Additionally, the range computing section 42 acquires the charge amounts Q1sd and Q2sd respectively accumulated in the charge accumulators CS1 and CS2 in the second process. At step S11, the range computing section 42 sets one or both of the acquired charge amounts Q1ft and Q2ft as the charge amount Qb corresponding to the external light component. At step S12, the range computing section 42 calculates the charge amount Q2s using the acquired charge amounts Q1sd and Q2sd and the charge amount Qb. A method by which the range computing section 42 calculates the charge amount Q2s is the same as the case in which each pixel 321 of the range imaging apparatus 1 includes three charge accumulators CS1 to CS3 in the present modification.

As described above, the range imaging apparatus 1 of the present embodiment includes the light source unit 2, the light receiver 3, and the range image processor 4. The light source unit 2 emits the light pulse PO into the measurement space in which the subject OB exists. The light receiver 3 includes the pixels 321 and the vertical scanning circuit 323 (an example of a driver circuit). Each pixel 321 includes the photoelectric conversion device PD and multiple charge accumulators CS. The vertical scanning circuit 323 distributes and accumulates the electric charge in the charge accumulators CS of each pixel 321 at the points in time synchronized with the emission of the light pulse PO. The range image processor 4 determines the measurement distance to the subject OB using the charge amount accumulated in each charge accumulator CS. The range image processor 4 acquires the waveform information 440. The waveform information 440 is the information indicating the distortion degree of the waveform of the rectangular signal used in the signal processing until the measurement distance is determined. The range image processor 4 corrects, based on the acquired waveform information 440, the charge amounts (charge amounts Q1# and Q2#) accumulated in the charge accumulators CS to the charge amounts (charge amounts Q1h and Q2h) accumulated in a case in which the waveform of the rectangular signal has no distortion. The range image processor 4 determines the measurement distance using the corrected charge amounts.

Accordingly, the range imaging apparatus 1 of the embodiment corrects the charge amounts (charge amounts Q1# and Q2#) including errors caused by the waveform distortion to the charge amounts (charge amounts Q1h and Q2h) with errors being reduced. Thus, the measurement distance is accurately calculated even when waveform distortion is significant in the rectangular signal.

Additionally, in the range imaging apparatus 1 of the embodiment, the waveform information 440 includes the tail ratio indicating the ratio of the second area (area of the region Sc) to the first area (area of the region Sa+Sb) derived by time integration of the signal H1 and the signal H2 (an example of the rectangular signal). The first area is the integrated value obtained by integrating the rectangular signal H1 (rectangular signal without waveform distortion, which is an example of the “first signal”) from the rising start time Trs to the falling start time Tds. The second area is the integrated value obtained by integrating the subtracted value obtained by subtracting the tailing signal H2 (rectangular signal with waveform distortion, which is an example of the “second signal”) from the rectangular signal H1 from the rising start time Trs to the rising end time Tre. Alternatively, the second area may be an integrated value obtained by integrating the tailing signal H2 from the falling start time Tds to the falling end time Tde. The range image processor 4 calculates the charge amounts Q1# and Q2#. The charge amount Q1# is the charge amount obtained by subtracting the charge amount Qb corresponding to the external light component from the charge amount Q1 (first charge amount) accumulated in the charge accumulator CS1 (first charge accumulator). The charge amount Q2# is the charge amount obtained by subtracting the charge amount Qb corresponding to the external light component from the charge amount Q2 (second charge amount) accumulated in the charge accumulator CS2 (second charge accumulator). The charge accumulator CS1 is the charge accumulator CS in which the charge amount corresponding to the reflected light RL is accumulated first. The charge accumulator CS2 is the charge accumulator CS in which the charge amount corresponding to the reflected light RL is accumulated subsequent to the charge accumulator CS1. The range image processor 4 calculates the charge amount Q2s (first correction charge amount) using the waveform information 440. The charge amount Q2s is, of the charge amount Q2# corresponding to the reflected light RL accumulated in the charge accumulator CS2, the charge amount that was not accumulated in the charge accumulator CS1 and accumulated in the charge accumulator CS2 due to the distortion of the rectangular signal. The range image processor 4 calculates the charge amount Q1h by correcting the charge amount Q1# as in, for example, equation (6) or equation (11) using the charge amount Q2s. Additionally, the range image processor 4 calculates the charge amount Q2h by correcting the charge amount Q2# as in, for example, equation (12) using the charge amount Q2s.

Accordingly, the range imaging apparatus 1 of the embodiment calculates the charge amount Q2s that was not accumulated in the charge accumulator CS1 and undesirably accumulated in the charge accumulator CS2 due to waveform distortion. Thus, the charge amount that was supposed to be accumulated in the charge accumulator CS1 is corrected to be restored, enabling the measurement distance to be accurately calculated.

Furthermore, in the range imaging apparatus 1 of the embodiment, each pixel 321 includes three charge accumulators CS1 to CS3. The range image processor 4 controls the points in time at which the electric charge is accumulated so that the electric charge corresponding to the reflected light RL is not accumulated in, among the three charge accumulators CS, the charge accumulator CS other than the charge accumulator CS1 and the charge accumulator CS2 (the charge accumulator CS3, which is an example of the “external light charge accumulator”). The range image processor 4 sets the charge amount accumulated in the charge accumulator CS3 as the charge amount Qb corresponding to the external light component. This allows the range imaging apparatus 1 of the embodiment to calculate the charge amounts Q1, Q2, and Qb obtained by distributing and accumulating the reflected light RL in one frame. Thus, the processing time is reduced compared with a case in which the measurement distance is determined by performing the accumulation and readout processes in two frames involving the first process and the second process.

Furthermore, in the range imaging apparatus 1 of the embodiment, each pixel 321 includes three charge accumulators CS1 to CS3. The waveform information 440 includes the tail ratio indicating the ratio of the second area (area of the region Sc) to the first area (area of the region Sa+Sb) derived by time integration of the signal H1 and the signal H2 (an example of the rectangular signal). The first area is the integrated value obtained by integrating the rectangular signal H1 (rectangular signal without waveform distortion, which is an example of the “first signal”) from the rising start time Trs to the falling start time Tds. The second area is the integrated value obtained by integrating the subtracted value obtained by subtracting the tailing signal H2 (rectangular signal with waveform distortion, which is an example of the “second signal”) from the rectangular signal H1 from the rising start time Trs to the rising end time Tre. Alternatively, the second area may be an integrated value obtained by integrating the tailing signal H2 from the falling start time Tds to the falling end time Tde. The range image processor 4 calculates the charge amounts Q1#, Q2#, and Q3#. The charge amount Q1# is the charge amount obtained by subtracting the charge amount Qb corresponding to the external light component from the charge amount Q1 (first charge amount) accumulated in the charge accumulator CS1 (first charge accumulator). The charge amount Q2# is the charge amount obtained by subtracting the charge amount Qb corresponding to the external light component from the charge amount Q2 (second charge amount) accumulated in the charge accumulator CS2 (second charge accumulator). The charge amount Q3# is the charge amount obtained by subtracting the charge amount Qb corresponding to the external light component from the charge amount Q3 (third charge amount) accumulated in the charge accumulator CS3 (third charge accumulator). The charge accumulator CS1 is the charge accumulator CS in which the charge amount corresponding to the reflected light RL is accumulated first. The charge accumulator CS2 is the charge accumulator CS in which the charge amount corresponding to the reflected light RL is accumulated subsequent to the charge accumulator CS1. The charge accumulator CS3 is the charge accumulator CS in which the charge amount corresponding to the reflected light RL is accumulated subsequent to the charge accumulator CS2. The range image processor 4 calculates the charge amount Q2s (first correction charge amount) using the waveform information 440. The range image processor 4 calculates the charge amount Q3# (second correction charge amount) using the waveform information 440. The charge amount Q2s is, of the charge amount Q2# corresponding to the reflected light RL accumulated in the charge accumulator CS2, the charge amount that was not accumulated in the charge accumulator CS1 and accumulated in the charge accumulator CS2 due to the distortion of the rectangular signal. The charge amount Q3# is the charge amount that was not accumulated in the charge accumulator CS2 and accumulated in the charge accumulator CS3 due to the distortion of the rectangular signal. The range image processor 4 calculates the charge amount Q1h by correcting the charge amount Q1# as in, for example, equation (6) or equation (11) using the charge amount Q2s. Additionally, the range image processor 4 calculates the charge amount Q2h by correcting the charge amount Q2# as in, for example, equation (7) using the charge amounts Q2s and Q3#.

Accordingly, the range imaging apparatus 1 of the embodiment calculates the charge amount Q3# that was undesirably accumulated in the charge accumulator CS3 even when the waveform distortion caused the electric charge corresponding to the reflected light RL to be accumulated in the charge accumulator CS3 in which no electric charge corresponding to the reflected light RL was supposed to be accumulated. Thus, the charge amount that was supposed to be accumulated in the charge accumulator CS2 is corrected to be restored, enabling the measurement distance to be accurately calculated.

Furthermore, in the range imaging apparatus 1 of the embodiment, each pixel 321 includes four charge accumulators CS1 to CS4. The range image processor 4 controls the points in time at which the electric charge is accumulated so that the electric charge corresponding to the reflected light RL is not accumulated in, among the four charge accumulators CS1 to CS4, the charge accumulator CS other than the charge accumulators CS1 to CS3 (the charge accumulator CS4, which is an example of the “external light charge accumulator”). The range image processor sets the charge amount accumulated in the charge accumulator CS4 as the charge amount Qb corresponding to the external light component. This allows the range imaging apparatus 1 of the embodiment to calculate the charge amounts Q1, Q2, Q3, and Qb obtained by distributing and accumulating the reflected light RL in one frame. Thus, the processing time is reduced compared with a case in which the measurement distance is determined by performing the accumulation and readout processes in two frames involving the first process and the second process. The advantageous effect achieved by the range imaging apparatus 1 of the embodiment will now be described with reference to FIG. 13. FIG. 13 is a graph illustrating the advantageous effect of the embodiment. FIG. 13 illustrates the relationship between the distance in reality (actual distance) and the measurement distance. In FIG. 13, the horizontal axis indicates the actual distance, and the vertical axis indicates the measurement distance. The distance as used herein refers to the distance to the subject OB. In FIG. 13, the measurement distances without correction shown by filled circles are the distances calculated by, for example, substituting the charge amounts Q1 to Q3 in equation (1). The corrected measurement distances shown by filled triangles are the distances calculated using the corrected charge amounts Q1h and Q2h calculated by correcting as in, for example, equation (6) and equation (7) using the waveform information 440. As illustrated in the graph, the corrected measurement distances match the actual distances. The measurement distances without correction do not match the actual distances and have values including errors. That is, the range imaging apparatus 1 of the present embodiment can calculate a value closer to the actual distance by determining the measurement distance using the waveform information 440.

### Modification of Embodiment

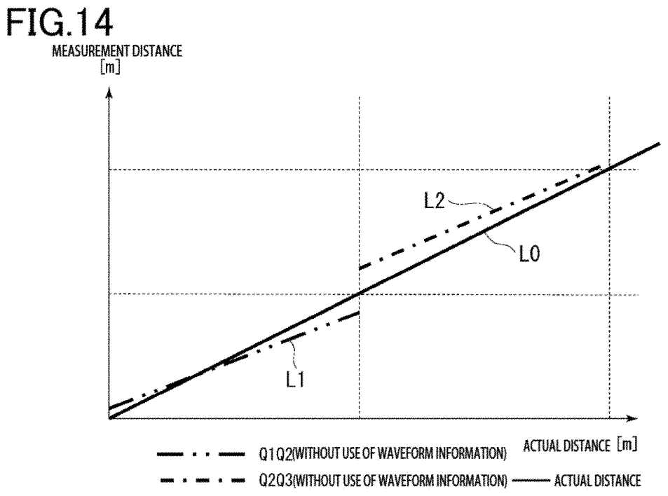

FIG. 14 is a graph illustrating the properties of two time windows according to a modification of the embodiment. The properties as used herein indicate the correspondence relationship between the actual distance and the measurement distance. In FIG. 14, the horizontal axis indicates the actual distance, and the vertical axis indicates the measurement distance. A property LO indicates the ideal relationship between the actual distance and the measurement distance. A property L1 indicates the relationship between the actual distance and the measurement distance in a first time window. A property L2 indicates the relationship between the actual distance and the measurement distance in a second time window. As illustrated by an example shown in the graph, the correspondence relationship between the actual distance and the measurement distance differs between one time window and another time window. Thus, correcting a distance in one time window using the waveform information 440 that can accurately correct the distance in another time window does not necessarily result in accurate correction.

As a countermeasure against this, in the present modification, the waveform information 440 for each time window is previously created and stored in the storage 44. Thus, even when the deviation (error) between the measurement distance and the actual distance varies per time window, the waveform information 440 corresponding to each time window is used, which enables the distance to be easily and accurately calculated.

All or part of the range imaging apparatus 1 and the range image processor 4 according to the above-described embodiment may be achieved by a computer. In this case, a program that achieves this function may be recorded on a computer-readable recording medium so that a computer system can read and run the program recorded on the recording medium. The “computer system” referred to herein includes an operating system (OS) and hardware such as peripheral devices. The “computer-readable recording medium” refers to a storage device such as a portable medium, e.g., a flexible disk, a magneto-optical disk, a ROM, a CD-ROM or the like, or a hard disk incorporated in the computer system. The “computer-readable recording medium” may include a medium that dynamically retains a program for a short period of time, such as a communication line that transmits a program through a network such as the interne or a telecommunication line such as a telephone line, or a medium that retains the program for a given period of time in that case, such as a volatile memory of a computer system that serves as a server or a client. The above programs may achieve part of the functions described above, or may achieve the functions in combination with programs already recorded in a computer system, or may achieve the functions by using a programmable logic device, such as an FPGA.

An embodiment of the present invention accurately calculates a measurement distance even when waveform distortion is significant in a rectangular signal used in measuring a distance.

Conventionally, there is a technique for measuring time-of-flight of a light pulse as a technique for measuring the distance to an object. Such a technique is referred to as a time-of-flight (hereinafter, referred to as TOF) technique. The TOF technique utilizes the fact that the speed of light is known and irradiates an object with a light pulse in a near-infrared region. The technique measures the time difference between the time at which the light pulse is emitted and the time at which reflected light, which is the emitted light pulse reflected off the object, is received. The distance to the object is calculated based on the time difference. Ranging sensors that detect the light for measuring the distance using photodiodes (photoelectric conversion devices) have been put to practical use.

In recent years, ranging sensors have been put to practical use that obtain not only the distance to an object but also depth information per pixel in a two-dimensional image including the object, that is, three-dimensional information of the object. Such a ranging sensor is also referred to as a range imaging apparatus. In the range imaging apparatus, multiple pixels including photodiodes are arranged on a silicon substrate in a two-dimensional matrix. The reflected light reflected off an object is received by this pixel surface. The range imaging apparatus obtains a two-dimensional image including the object and range information per individual pixel constituting the image by outputting a photoelectric conversion signal based on the light quantity (electric charge) received by individual pixel for one image. For example, JP 4235729 B describes a technique in which each pixel includes three charge accumulators and that calculates the distance by distributing the electric charge in order.

Such a range imaging apparatus includes a short-pulse method in which a light pulse is intermittently emitted and a continuous-wave method in which light is continuously emitted. In the short-pulse method, accumulating electric charge while maintaining a rectangular waveform of the light pulse and the reflected light is important in maintaining the accuracy of the measurement distance. That is, a timing signal of a driver controlling a laser diode that emits a light pulse and a gate signal that accumulates an electric charge in a charge accumulator are maintained in a rectangular form. However, a delay occurs at a rising edge and a falling edge of the rectangle due to a signal delay in a circuit or the charge transfer efficiency in the photoelectric conversion device, which results in the occurrence of waveform distortion. In particular, the waveform distortion becomes significant when the width of the rectangle (pulse width) is reduced aiming at, for example, improving the processing speed. When waveform distortion becomes significant, the accumulated amount of the electric charge greatly changes from the original accumulated amount, which undesirably causes an error in the measurement distance. As a countermeasure against this, the deviation (error) of the measurement distance may be corrected by polynomial approximation. This, however, increases the processing load and amplifies noise in higher-order terms, thereby raising issues such as deteriorating the distance accuracy. Additionally, if there are multiple time windows, the degree of deviation in the measurement distance differs between individual time windows. Thus, correcting the distance by polynomial approximation in multiple time windows complicates the processing, making it difficult to perform calculation.

A range imaging apparatus and a range imaging method according to embodiments of the present invention accurately calculate a measurement distance even when waveform distortion is significant in a rectangular signal used in measuring a distance.

A range imaging apparatus according to an embodiment of the present invention includes: a light source unit that emits a light pulse to a measurement space in which a subject exists; a light receiver including pixels each including a photoelectric conversion device that generates an electric charge corresponding to incident light and charge accumulators that stores the electric charge, and a pixel driver circuit that distributes and stores the electric charge to each of the charge accumulators of each pixel at a predetermined point in time synchronized with the emission of the light pulse; and a range image processor determines a measurement distance to the subject using charge amounts indicating respective amounts of the electric charge stored in the charge accumulators. The range image processor acquires waveform information indicating a degree of distortion of a waveform of a rectangular signal having a distorted waveform, the rectangular signal being used in signal processing performed until the measurement distance is determined, correct, based on the acquired waveform information, the charge amounts to respective charge amounts each indicating an amount of electric charge that would be stored if the rectangular signal is a rectangular signal in which the waveform has no distortion, and determine the measurement distance using the corrected charge amounts.

In a range imaging apparatus according to an embodiment of the present invention, the waveform information includes a tail ratio indicating a ratio of a second area to a first area, the first area and the second area being derived by time integration of the rectangular signal in which the waveform has no distortion and the rectangular signal having the distorted waveform, respectively, the first area is an integrated value obtained by integrating a first signal from a rising start time to a falling start time, the first signal being the rectangular signal in which the waveform has no distortion, the second area is an integrated value obtained by integrating a subtracted value from the rising start time to a rising end time, or an integrated value obtained by integrating a second signal from the falling start time to a falling end time, the second signal being the rectangular signal having the distorted waveform, the subtracted value being obtained by subtracting the second signal from the first signal. The charge accumulators of each pixel include a first charge accumulator and a second charge accumulator, the first charge accumulator first storing an electric charge corresponding to reflected light which is the light pulse reflected off the subject, the second charge accumulator storing the electric charge corresponding to the reflected light subsequent to the first charge accumulator, and the range image processor calculates a first range computation charge amount and a second range computation charge amount, the first range computation charge amount being obtained by subtracting a charge amount corresponding to an external light component from a first charge amount indicating an amount of the electric charge stored in the first charge accumulator, the second range computation charge amount being obtained by subtracting the charge amount corresponding to the external light component from a second charge amount indicating an amount of the electric charge stored in the second charge accumulator, calculate, using the waveform information, a first correction charge amount indicating an amount of electric charge stored not in the first charge accumulator but in the second charge accumulator due to the distortion of the waveform of the rectangular signal, the first correction charge amount being part of the second range computation charge amount, and correct the first range computation charge amount and the second range computation charge amount using the first correction charge amount.

In a range imaging apparatus according to an embodiment of the present invention, the charge accumulators of each pixel include three charge accumulators including the first charge accumulator, the second charge accumulator, and an external light charge accumulator as a third charge accumulator. The range image processor controls a point in time at which an electric charge is stored in the external light charge accumulator, so as to prevent the external light charge accumulator from storing the electric charge corresponding to the reflected light, and set an amount of the electric charge stored in the external light charge accumulator as the charge amount corresponding to the external light component.

In a range imaging apparatus according to an embodiment of the present invention, the charge accumulators of each pixel include three charge accumulators. The waveform information includes a tail ratio indicating a ratio of a second area to a first area, the first area and the second area being derived by time integration of the rectangular signal in which the waveform has no distortion and the rectangular signal having the distorted waveform, respectively; the first area is an integrated value obtained by integrating a first signal from a rising start time to a falling start time, the first signal being the rectangular signal in which the waveform has no distortion; and the second area is an integrated value obtained by integrating a subtracted value from the rising start time to a rising end time, or an integrated value obtained by integrating a second signal from the falling start time to a falling end time, the second signal being the rectangular signal having the distorted waveform, the substracted value being obtained by subtracting the second signal from the first signal. The three charge accumulators of each pixel include a first charge accumulator, a second charge accumulator, and a third charge accumulator, the first charge accumulator first storing an electric charge corresponding to reflected light which is the light pulse reflected off the subject, the second charge accumulator storing the electric charge corresponding to the reflected light subsequent to the first charge accumulator, the third charge accumulator storing the electric charge corresponding to the reflected light subsequent to the second charge accumulator; and the range image processor calculates a first range computation charge amount, a second range computation charge amount, and a third range computation charge amount, the first range computation charge amount being obtained by subtracting a charge amount corresponding to an external light component from a first charge amount indicating an amount of the electric charge stored in the first charge accumulator, the second range computation charge amount being obtained by subtracting the charge amount corresponding to the external light component from a second charge amount indicating an amount of the electric charge stored in the second charge accumulator, the third range computation charge amount being obtained by subtracting the charge amount corresponding to the external light component from a third charge amount indicating an amount of the electric charge stored in the third charge accumulator, calculate, using the waveform information, a first correction charge amount indicating an amount of electric charge stored not in the first charge accumulator but in the second charge accumulator due to the distortion of the waveform of the rectangular signal, the first correction charge amount being part of the second range computation charge amount, calculate, using the waveform information, a second correction charge amount indicating an amount of electric charge stored not in the second charge accumulator but in the third charge accumulator due to the distortion of the waveform of the rectangular signal, the second correction charge amount being part of the third range computation charge amount, correct the first range computation charge amount using the first correction charge amount, and correct the second range computation charge amount using the first correction charge amount and the second correction charge amount.

In a range imaging apparatus according to an embodiment of the present invention, the charge accumulators of each pixel include four charge accumulators including the first charge accumulator, the second charge accumulator, the third charge accumulator, and an external light charge accumulator as a fourth charge accumulator. The range image processor controls a point in time at which an electric charge is stored in the external light charge accumulator, so as to prevent the external light charge accumulator from storing the electric charge corresponding to the reflected light, and set an amount of the electric charge stored in the external light charge accumulator as the charge amount corresponding to the external light component.

A range imaging method according to an embodiment of the present invention is a range imaging method performed by a range imaging apparatus including a light source unit that emits a light pulse to a measurement space in which a subject exists, a light receiver including pixels each including a photoelectric conversion device that generates an electric charge corresponding to incident light and charge accumulators that store the electric charge, and a pixel driver circuit that distributes and stores the electric charge to each of the charge accumulators of each pixel at a predetermined point in time synchronized with the emission of the light pulse, and a range image processor that determines a measurement distance to the subject using charge amounts indicating respective amounts of the electric charge stored in the charge accumulators. The method includes causing the range image processor to acquire waveform information indicating a degree of distortion of a waveform of a rectangular signal having a distorted waveform, the rectangular signal being used in signal processing performed until the measurement distance is determined, correct, based on the acquired waveform information, the charge amounts to respective charge amounts each indicating an amount of electric charge that would be stored if the rectangular signal is a rectangular signal in which the waveform has no distortion, and determine the measurement distance using the corrected charge amounts.

An embodiment of the present invention accurately calculates a measurement distance even when waveform distortion is significant in a rectangular signal used in measuring a distance.

Obviously, numerous modifications and variations of the present invention are possible in light of the above teachings. It is therefore to be understood that within the scope of the appended claims, the invention may be practiced otherwise than as specifically described herein.

1. A range imaging apparatus, comprising:
a light source unit configured to emit a light pulse to a measurement space;
a light receiver including a plurality of pixels and a pixel driver circuit; and
range image processor configured to determine a measurement distance to a subject placed in the measurement space,
wherein each of the pixels in the light receiver includes a photoelectric conversion device configured to generate an electric charge corresponding to incident light and a plurality of charge accumulators configured to store the electric charge, the pixel driver circuit in the light receiver is configured to distribute and store the electric charge to each of the charge accumulators of each of the pixels at a predetermined point in time synchronized with emission of the light pulse, the range image processor is configured to acquire waveform information indicating a degree of distortion of a waveform of a rectangular signal having a distorted waveform, correct, based on the waveform information, charge amounts each indicating an amount of the electric charge that is stored when the waveform of the rectangular signal has no distortion, and determine the measurement distance to the subject using the charge amounts, and the rectangular signal is used in signal processing performed until the measurement distance is determined.

2. The range imaging apparatus according to claim 1, wherein the waveform information includes a tail ratio indicating a ratio of a second area to a first area such that the first area and the second area are derived by time integration of the rectangular signal in which the waveform has no distortion and the rectangular signal having the distorted waveform, respectively, the first area is an integrated value obtained by integrating a first signal from a rising start time to a falling start time such that the first signal is the rectangular signal in which the waveform has no distortion, the second area is an integrated value obtained by integrating a subtracted value from the rising start time to a rising end time, or an integrated value obtained by integrating a second signal from the falling start time to a falling end time such that the second signal is the rectangular signal having the distorted waveform and that the subtracted value is obtained by subtracting the second signal from the first signal, the plurality of charge accumulators of each of the pixels include a first charge accumulator and a second charge accumulator such that the first charge accumulator first stores an electric charge corresponding to reflected light which is the light pulse reflected off the subject and that the second charge accumulator stores the electric charge corresponding to the reflected light subsequent to the first charge accumulator, and the range image processor is configured to calculate a first range computation charge amount and a second range computation charge amount such that the first range computation charge amount is obtained by subtracting a charge amount corresponding to an external light component from a first charge amount indicating an amount of the electric charge stored in the first charge accumulator and that the second range computation charge amount is obtained by subtracting the charge amount corresponding to the external light component from a second charge amount indicating an amount of the electric charge stored in the second charge accumulator, calculate, using the waveform information, a first correction charge amount indicating an amount of electric charge stored not in the first charge accumulator but in the second charge accumulator due to the distortion of the waveform of the rectangular signal such that the first correction charge amount is part of the second range computation charge amount, and correct the first range computation charge amount and the second range computation charge amount using the first correction charge amount.

3. The range imaging apparatus according to claim 2, wherein the plurality of charge accumulators of each of the pixels comprise three charge accumulators including the first charge accumulator, the second charge accumulator, and a third charge accumulator comprising an external light charge accumulator, and the range image processor is configured to control a point in time at which an electric charge is stored in the external light charge accumulator such that the external light charge accumulator is prevented from storing the electric charge corresponding to the reflected light, and set an amount of the electric charge stored in the external light charge accumulator as the charge amount corresponding to the external light component.

4. The range imaging apparatus according to claim 1, wherein the plurality of charge accumulators of each of the pixels comprise three charge accumulators, the waveform information includes a tail ratio indicating a ratio of a second area to a first area such that the first area and the second area are derived by time integration of the rectangular signal in which the waveform has no distortion and the rectangular signal having the distorted waveform, respectively, the first area is an integrated value obtained by integrating a first signal from a rising start time to a falling start time such that the first signal is the rectangular signal in which the waveform has no distortion, the second area is an integrated value obtained by integrating a subtracted value from the rising start time to a rising end time or an integrated value obtained by integrating a second signal from the falling start time to a falling end time such that the second signal is the rectangular signal having the distorted waveform and that the subtracted value is obtained by subtracting the second signal from the first signal, the three charge accumulators of each of the pixels include a first charge accumulator, a second charge accumulator, and a third charge accumulator such that the first charge accumulator first stores an electric charge corresponding to reflected light which is the light pulse reflected off the subject and that the second charge accumulator stores the electric charge corresponding to the reflected light subsequent to the first charge accumulator, the third charge accumulator storing the electric charge corresponding to the reflected light subsequent to the second charge accumulator, and the range image processor is configured to calculate a first range computation charge amount, a second range computation charge amount, and a third range computation charge amount such that the first range computation charge amount is obtained by subtracting a charge amount corresponding to an external light component from a first charge amount indicating an amount of the electric charge stored in the first charge accumulator, that the second range computation charge amount is obtained by subtracting the charge amount corresponding to the external light component from a second charge amount indicating an amount of the electric charge stored in the second charge accumulator, and that the third range computation charge amount is obtained by subtracting the charge amount corresponding to the external light component from a third charge amount indicating an amount of the electric charge stored in the third charge accumulator, calculate, using the waveform information, a first correction charge amount indicating an amount of electric charge stored not in the first charge accumulator but in the second charge accumulator due to the distortion of the waveform of the rectangular signal such that the first correction charge amount is part of the second range computation charge amount, calculate, using the waveform information, a second correction charge amount indicating an amount of electric charge stored not in the second charge accumulator but in the third charge accumulator due to the distortion of the waveform of the rectangular signal such that the second correction charge amount is part of the third range computation charge amount, correct the first range computation charge amount using the first correction charge amount, and correct the second range computation charge amount using the first correction charge amount and the second correction charge amount.

5. The range imaging apparatus according to claim 4, wherein the plurality of charge accumulators of each of the pixels comprise four charge accumulators including the first charge accumulator, the second charge accumulator, the third charge accumulator, and a fourth charge accumulator comprising an external light charge accumulator, and the range image processor is configured to control a point in time at which an electric charge is stored in the external light charge accumulator such that the external light charge accumulator is prevented from storing the electric charge corresponding to the reflected light, and set an amount of the electric charge stored in the external light charge accumulator as the charge amount corresponding to the external light component.

6. A range imaging method, comprising:
providing a range imaging apparatus including a light source unit configured to emit a light pulse to a measurement space, a light receiver including a plurality of pixels and a pixel driver circuit, and a range image processor configured to determine a measurement distance to a subject in the measurement space;
causing a range image processor to acquire waveform information indicating a degree of distortion of a waveform of a rectangular signal having a distorted waveform;
correct, based on the waveform information, charge amounts each indicating an amount of an electric charge that is stored when the waveform of the rectangular signal has no distortion; and
determine the measurement distance to the subject using the charge amounts,
wherein each of the pixels in the light receiver includes a photoelectric conversion device configured to generate the electric charge corresponding to incident light and a plurality of charge accumulators configured to store the electric charge, the pixel driver circuit in the light receiver is configured to distribute and store the electric charge to each of the charge accumulators of each of the pixels at a predetermined point in time synchronized with emission of the light pulse, the range image processor is configured to acquire the waveform information, correct the charge amounts based on the waveform information, and determine the measurement distance to the subject, and the rectangular signal is used in signal processing performed until the measurement distance is determined.

7. The range imaging method of claim 6, wherein the waveform information includes a tail ratio indicating a ratio of a second area to a first area such that the first area and the second area are derived by time integration of the rectangular signal in which the waveform has no distortion and the rectangular signal having the distorted waveform, respectively, the first area is an integrated value obtained by integrating a first signal from a rising start time to a falling start time such that the first signal is the rectangular signal in which the waveform has no distortion, the second area is an integrated value obtained by integrating a subtracted value from the rising start time to a rising end time, or an integrated value obtained by integrating a second signal from the falling start time to a falling end time such that the second signal is the rectangular signal having the distorted waveform and that the subtracted value is obtained by subtracting the second signal from the first signal, the plurality of charge accumulators of each of the pixels include a first charge accumulator and a second charge accumulator such that the first charge accumulator first stores an electric charge corresponding to reflected light which is the light pulse reflected off the subject and that the second charge accumulator stores the electric charge corresponding to the reflected light subsequent to the first charge accumulator, and the range image processor is configured to calculate a first range computation charge amount and a second range computation charge amount such that the first range computation charge amount is obtained by subtracting a charge amount corresponding to an external light component from a first charge amount indicating an amount of the electric charge stored in the first charge accumulator and that the second range computation charge amount is obtained by subtracting the charge amount corresponding to the external light component from a second charge amount indicating an amount of the electric charge stored in the second charge accumulator, calculate, using the waveform information, a first correction charge amount indicating an amount of electric charge stored not in the first charge accumulator but in the second charge accumulator due to the distortion of the waveform of the rectangular signal such that the first correction charge amount is part of the second range computation charge amount, and correct the first range computation charge amount and the second range computation charge amount using the first correction charge amount.

8. The range imaging method of claim 7, wherein the plurality of charge accumulators of each of the pixels comprise three charge accumulators including the first charge accumulator, the second charge accumulator, and a third charge accumulator comprising an external light charge accumulator, and the range image processor is configured to control a point in time at which an electric charge is stored in the external light charge accumulator such that the external light charge accumulator is prevented from storing the electric charge corresponding to the reflected light, and set an amount of the electric charge stored in the external light charge accumulator as the charge amount corresponding to the external light component.

9. The range imaging method of claim 6, wherein the plurality of charge accumulators of each of the pixels comprise three charge accumulators, the waveform information includes a tail ratio indicating a ratio of a second area to a first area such that the first area and the second area are derived by time integration of the rectangular signal in which the waveform has no distortion and the rectangular signal having the distorted waveform, respectively, the first area is an integrated value obtained by integrating a first signal from a rising start time to a falling start time such that the first signal is the rectangular signal in which the waveform has no distortion, the second area is an integrated value obtained by integrating a subtracted value from the rising start time to a rising end time or an integrated value obtained by integrating a second signal from the falling start time to a falling end time such that the second signal is the rectangular signal having the distorted waveform and that the subtracted value is obtained by subtracting the second signal from the first signal, the three charge accumulators of each of the pixels include a first charge accumulator, a second charge accumulator, and a third charge accumulator such that the first charge accumulator first stores an electric charge corresponding to reflected light which is the light pulse reflected off the subject and that the second charge accumulator stores the electric charge corresponding to the reflected light subsequent to the first charge accumulator, the third charge accumulator storing the electric charge corresponding to the reflected light subsequent to the second charge accumulator, and the range image processor is configured to calculate a first range computation charge amount, a second range computation charge amount, and a third range computation charge amount such that the first range computation charge amount is obtained by subtracting a charge amount corresponding to an external light component from a first charge amount indicating an amount of the electric charge stored in the first charge accumulator, that the second range computation charge amount is obtained by subtracting the charge amount corresponding to the external light component from a second charge amount indicating an amount of the electric charge stored in the second charge accumulator, and that the third range computation charge amount is obtained by subtracting the charge amount corresponding to the external light component from a third charge amount indicating an amount of the electric charge stored in the third charge accumulator, calculate, using the waveform information, a first correction charge amount indicating an amount of electric charge stored not in the first charge accumulator but in the second charge accumulator due to the distortion of the waveform of the rectangular signal such that the first correction charge amount is part of the second range computation charge amount, calculate, using the waveform information, a second correction charge amount indicating an amount of electric charge stored not in the second charge accumulator but in the third charge accumulator due to the distortion of the waveform of the rectangular signal such that the second correction charge amount is part of the third range computation charge amount, correct the first range computation charge amount using the first correction charge amount, and correct the second range computation charge amount using the first correction charge amount and the second correction charge amount.

10. The range imaging method of claim 9, wherein the plurality of charge accumulators of each of the pixels comprise four charge accumulators including the first charge accumulator, the second charge accumulator, the third charge accumulator, and a fourth charge accumulator comprising an external light charge accumulator, and the range image processor is configured to control a point in time at which an electric charge is stored in the external light charge accumulator such that the external light charge accumulator is prevented from storing the electric charge corresponding to the reflected light, and set an amount of the electric charge stored in the external light charge accumulator as the charge amount corresponding to the external light component.
